(19) United States
(12) Patent Application Publication
(10) Pub. No.: US 2021/0216911 A1
(43) Pub. Date: Jul. 15, 2021

(54) SYSTEMS AND METHODS ASSOCIATED WITH MULTI DATA TYPE MULTI DATA SET ARTIFICIAL INTELLIGENCE PACKAGES, MACHINE LEARNING PACKAGES AND MATHEMATICAL SYSTEMS

(71) Applicants: Mark Nataros, Thornton, NH (US); Charles Gaius Floyd, Dallas, TX (US)

(72) Inventors: Mark Nataros, Thornton, NH (US); Charles Gaius Floyd, Dallas, TX (US)

(73) Assignee: Applied Artificial Sciences, LLC, Dallas, TX (US)

(21) Appl. No.: 17/128,895

(22) Filed: Dec. 21, 2020

Related U.S. Application Data
(60) Provisional application No. 62/960,836, filed on Jan. 14, 2020.

(51) Int. Cl. G06N 20/00; G06N 5/04; H04L 29/06; G06F 16/21

(52) U.S. Cl. CPC G06N 20/00; G06F 16/21; H04L 63/0428; G06N 5/04

(57) ABSTRACT

Utilizing and creating custom multi discipline Artificial Intelligence by persons with minimum Artificial Intelligence knowledge while minimizing multi field expertise required and limiting data and component access requirements.

### BACKGROUND INFORMATION

### Field of the Disclosure

Embodiments disclose utilizing and creating custom multi discipline Artificial Intelligence systems by persons with minimum Artificial Intelligence knowledge while minimizing multi field expertise required and limiting data and component access requirements.

### Background

Technology in Artificial Intelligence now requires experts in Artificial Intelligence, Machine Learning and Mathematical and Probabilistic Systems (herein referenced as AI/ML/MS for simplicity and ease of reading) to create new useful systems on a case by case bases. A problem arises when an expert in a field other than Artificial Intelligence, Machine Learning and Mathematical Systems requires a new case of solutions for their data and cannot or does not want to develop complex customized systems for the prediction of a wanted data set or identification and categorization of a wanted data set.

This problem is highly prevalent with business to customer relations, new specific cases of “Internet of Things” (IOT) as well as businesses wanting to utilize Artificial Intelligence with little or no expertise in the area of Artificial Intelligence, Machine Learning and Mathematical Systems required for such solutions. Additionally the desire to implement this in a way that restricts access to sensitive data while maintaining a competitive advantage by obfuscation of implementation while allowing on experts in fields to focus on their field without reliance on multi field discipline expertise.

Even when possible and practical to create such systems a large amount of overhead is generated by the business in the time for creating the system, the staffing, the hardware and software required, the optimizations required and understanding what data they need to maintain and prepare in order to result in optimized predictive results specific to a given case.

The problem now presented by such cases is one of “time” in the production of valuable insight and “costs” in terms of creating valid solutions. Real-world implementation considerations and requirements for creating an Artificial Intelligence system is leaving many businesses unable or unwilling to implement Artificial Intelligence capable systems in a practical and valuable way to their business.

One such reason is the inherent inability of Artificial Intelligence systems to understand and optimize bidirectionally such that the system can interpret the client's data set, create solutions from it and understand what parts of that data are required for solving a problem posed. Also returning the information related to input optimization for the client and the results of the predictions to the client. Both providing results and providing training for the client in the use of a custom generated system of complex Artificial Intelligence, Machine Learning and Mathematical Systems. This is only further complicated when combined with the necessary ability to evaluate multiple Artificial Intelligence, Machine Learning and Mathematical Systems libraries both generic and custom designed simultaneously while considering the historical solutions for these types of results pertinent to the wanted prediction data set. A solution to this problem remains highly desirable.

An additional reason is expansion of capabilities, maintenance, and configuration over the lifespan of the system. A system that allows experts in AI that are not experts in a given field related to the data being processed and a system that allows experts in a given field related to the data being processed but not in AI to both actively contribute independently allows for a greater accessibility to AI in than traditional AI systems. An additional reason is the restriction of sensitive data, such to allow an expert in a field requiring access to sensitive data to be able to utilize AI's capabilities without being required to learn AI systems and to allow AI experts to contribute without direct access to the sensitive data. This is becoming more required such as under recent European data privacy laws.

### SUMMARY

Embodiments disclosed herein are directions towards a three-tiered approach to ensure operation and optimization of a level adequate for use in multiple disciplines, multiple data sets and multiple data types. This allows for experts in AI to operate in a lower layer without day to day concern of specific field specific information while experts in the field(s) related to the data being processed operate predominantly at the higher layer without the concern for specific AI functionality. This allows for each expert to maintain focus on their area of expertise without spending time cross training for each case.

Part 1: Artificial Intelligent result interpretation and optimization of client data set.

Part 2: Artificial Intelligent management and optimization of underlying collections of Artificial Intelligent, Machine Learning and Mathematical Systems in addition to the splitting and recombination of subsets of data and projections to best solve questions from (Tier 1) using data from (Tier 1).

Part 3: Collections of Artificial Intelligent and mathematical systems for the prediction of specific fields as specified by (Tier 2).

Further solutions include the ability to add and enhance any part of the collection of (Tier 1), (Tier 2), or (Tier 3) by experts in Artificial Intelligence and mathematical systems for the better understanding and optimization of result determination and of collections of Artificial Intelligence, Machine Learning and Mathematical Systems used throughout.

This overcomes prior art by allowing a collection of multi discipline multi data type multi data set Artificial Intelligence packages, Machine Learning packages and Mathematical Systems to be used by those not familiar with the field. Where in other systems are designed for specific complete optimizations on one narrow band of data where creating new analysis cases requires experts in the field the goal of this art is to allow for the understanding and utilization of multi discipline data and respond with a useful and meaningful set of predictions to those not an expert in Artificial Intelligence, Machine Learning and Mathematical Systems.

The three-tier approach also allows the input data to be optimized bidirectionally. Individual measurable properties or characteristics of a phenomenon being observed that are not predictive can be dropped. Additionally, cycles of data that do not add to predictions can be excluded. This allows for large amounts data to processed more efficiently by the underlying algorithms.

### BRIEF DESCRIPTION OF THE DRAWINGS

FIG. 1. Overview of System and Methods Described

FIG. 2. Tier 1 detailed logical flow of processing.

FIG. 3. Tier 2 detailed logical flow of processing.

FIG. 4. Tier 3 detailed logical flow of processing.

FIG. 5. Detailed flow of data throughout process. This diagram covers all methods of the application.

FIG. 6. Detailed flow of client interaction and client data flow and general interaction points.

### DETAILED DESCRIPTION

Described herein are the embodiments of a system and method for the utilization and creation of complex custom multi discipline Artificial Intelligence systems by persons with minimum Artificial Intelligence knowledge. Embodiments overcome the problems described above. Embodiments greatly reduce overhead for non-experts and increase availability of Artificial Intelligence systems to non-experts.

As used herein, an Artificial Intelligence (AI) is “a system's ability to correctly interpret external data, to learn from such data, and to use those learnings to achieve specific goals and tasks through flexible adaptation”. This may be a software and or hardware solution that is accessible by a higher-level library or interface or API that can be automated.

As used herein, a Machine Learning (ML) system is an application of Artificial Intelligence that provides systems the ability to automatically learn and improve from experience without being explicitly programmed. Machine learning focuses on the development of computer programs that can access data and use it learn for themselves. This may be a software and or hardware solution that is accessible by a higher-level library or interface or API that can be automated.

As used herein, a Mathematical and Probabilistic System (MS) is defined as any system of mathematical and or statistical formulas and equations that may be used to determine a solution for a specific classification of predictions, evaluations or optimizations that act in the use here “like” a Machine Learning or Artificial Intelligence system without meeting the technical definition of such. An example of this would be an entropy equation set to determine the degradation of trust in a data source due to noise introduced over time or another example is like-matching routines for customer sales prediction based on demographics of existing customers and advertising results, etc.

As used herein a client is the end user of the works resulting from the methods and systems outlined in this documentation. A customer is the entity whose data is being evaluated and results are being evaluated for. A client may or may not be a customer, a customer may or may not be a client.

As used herein a data set is all data related to a specific step in the overall process. The data set scope changes depending on what specific step in the process is occurring.

Referring now to the drawings, wherein like reference numbers are used herein to designate like elements throughout the various views and embodiments of a unit. The figures are not drawn to scale and have been exaggerated and or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

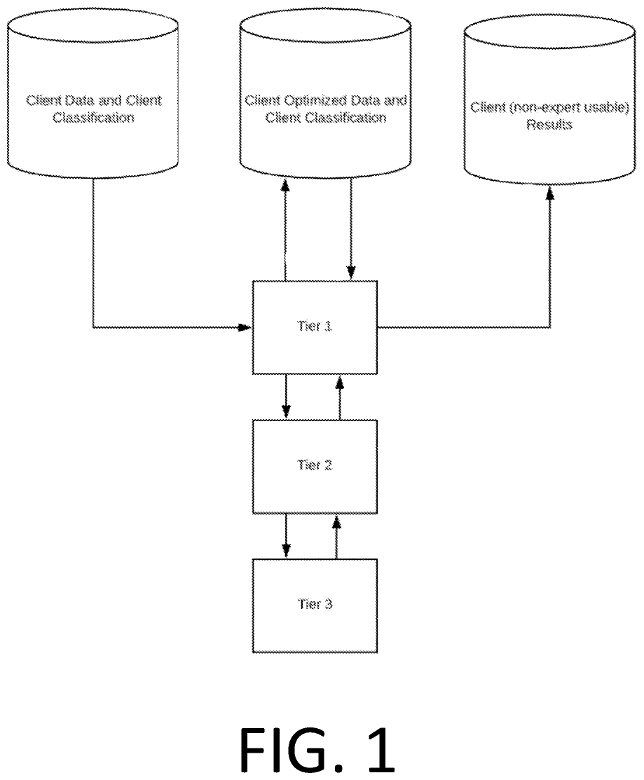

With reference now to FIG. 1, shown is the embodiment of the overall system and methods described herein.
1. A system consisting of three tiers of logically separated operations.
2. A system and methods for Tier 1 and data and notification flow to and from this tier.
3. A system and methods for Tier 2 and data and notification flow to and from this tier.
4. A system and methods for Tier 3 and data and notification flow to and from this tier.

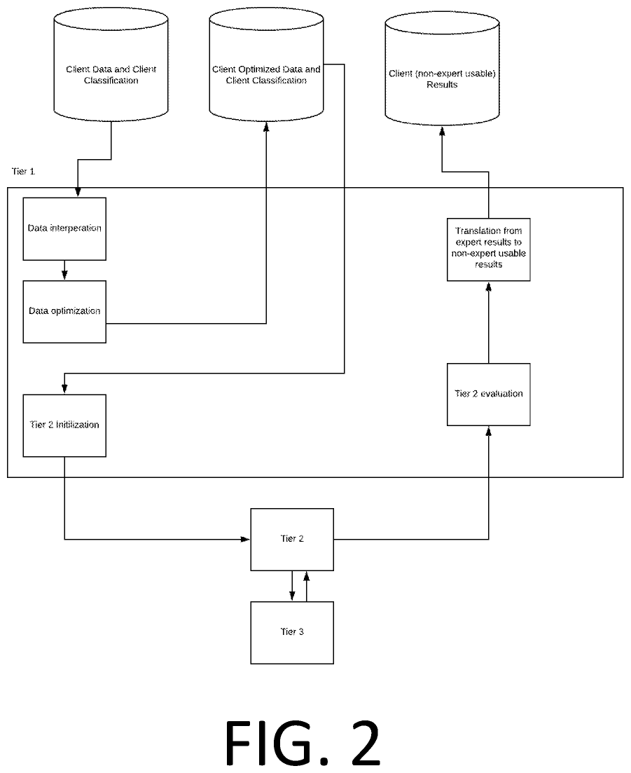

With reference now to FIG. 2, shown is the embodiment of Tier 1
1. A method of optimization to reduce the total data used for artificial intelligence forecasting and analysis.
   a. Method for selecting columns (multi-run, multi-cycle with deterministic metrics).
   b. Method for selecting time (such as a specific AI, ML and or MS process to determine a subset of the input dataset to utilize).
2. A method of analysis pertaining to data set splicing, with respect to time and data interpretation, such that optimization sets can be conducted as malleable sets of solution sets for each time set and their sub time set for each predictive case (customer data set and respective wanted prediction).
3. A method for understanding and interpreting client data. This is primarily data types analysis, date times interpretation and data normalization routines.
4. A method for instantiating Tier 2 operations with results from (1), (2), (3).
5. A method for translating the results from lower Tiers to client “human” understandable language not reliant on experts in the fields of Artificial Intelligence or mathematical systems.

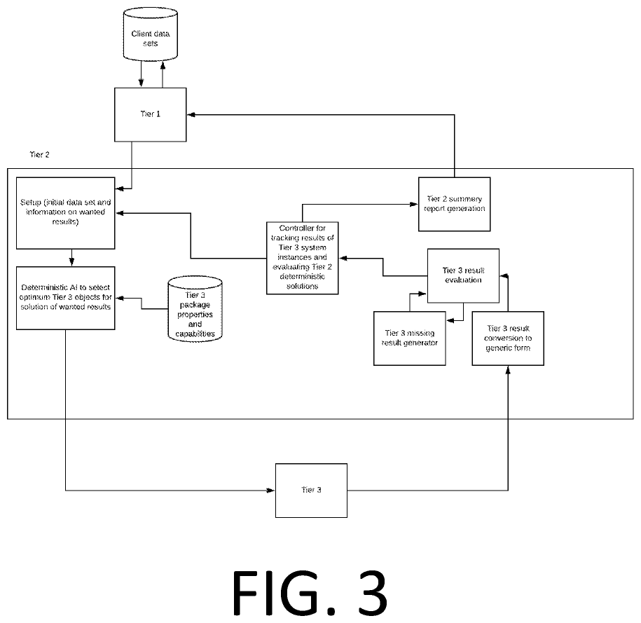

With reference now to FIG. 3, shown is the embodiment of Tier 2

This system embodies the methods of analysis to select the optimal combination of artificial intelligence calculations.
1. The method of analysis to select results pertaining to the predictive set wherein time is considered as a factor in generating subsequent instances of Tier 2 and Tier 3 operations considering and overall processing time, processing requirements, client requirements (cost of data versus accuracy and performance improvements). Additionally, data sets to be utilized are weighted by results corresponding to Tier 1 determined wanted predictive output and predictive data set.
2. A method of scheduling Tier 3 operations. This is comprised of two sections:
   a. Tier 3 self-determined cost. This allows the weight of the operations in Tier 3 to be self-determined (Tier wise) in terms of resources and time for the computation of in respects to the environment the process is executed in. This is then reported as a scheduling set to Tier 2 (b).
   b. Tier 2 compares the existing results from (a) and considers potential improvement of results expected for each configuration possible of Tier 3 instances with respect to (i,ii,iii) noted below in 2.b.i,2.b.ii,2.b.iii. Each of these are then weighted in order to schedule the next X number of Tier 3 instances where X is the number of concurrent Tier 3 instances that can be efficiently run based on (i,ii,iii) and the overall environment status and the time remaining for processing based on Tier 1s requirements that were used to initialize Tier 2.
      i. likelihood of improving results based on past run historical result improvement
      ii. likelihood of improvement results based on AI forecasting of Tier 3 results
      iii. likelihood of improving results based on current executed results in the same Tier 2 session.
3. A method of evaluating Tier 3 operations. This is comprised of self-responding elements from Tier 3 where available to generate lacking elements from self-responses and additional evaluations and transformations on the results to all for the direct comparison from aspirated* evaluations.
4. A method of splicing data queries for Tier 3 operations.
5. A method of recombination of Tier 3 results into a single data set for translation by Tier 1.

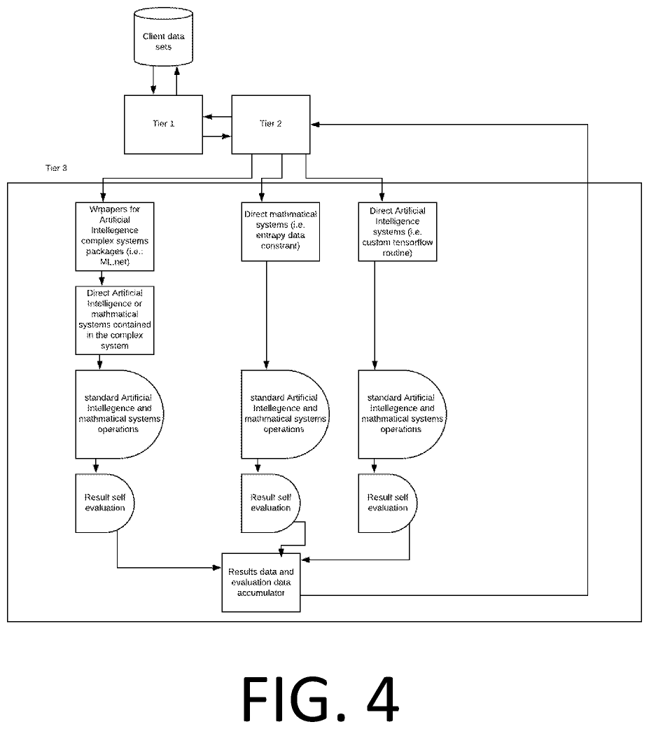

With reference now to FIG. 4, shown is the embodiment of Tier 3

One of the ordinary skill in the art will appreciate the many possible combinations of these methods described herein and does not mean that all claimed embodiments must include all referenced aspects.
A system consisting of collections of all Artificial Intelligence calculation engines (such as ML.net, TensorFlow, Keras, AutoKeras, etc.) as well as all mathematical systems engines that do not fall under a true Artificial Intelligence (such as statistical and probabilistic projections).
A method of controlling each component in (1) for various packages contained therein.
A method of reporting results for prediction or categorization requested by Tier 2.
A method of self-evaluation of result quality (such as back testing, Area under the curve, etc.) for Tier 2 to evaluate.

Additional examples of areas of models based on:
1. Market Analysis optimization (housing market, location predictions of transactions, location predictions of events, stock market, etc.)
2. AI/ML/MS in use with generating ads (end look, effectiveness measurement)
3. AI/ML/MS in use with determining best colors to use in ads and or products and or services
4. AI/ML/MS to use with video compression optimization in real time to determine best video compression settings to use for ‘future’ frames to minimize system impact and maximize video/audio/user interface quality.
5. AI/ML/MS to determine generic data prediction of time series data.
6. MS packages based on customer demographics.
7. MS packages based on standard forecasting of data.

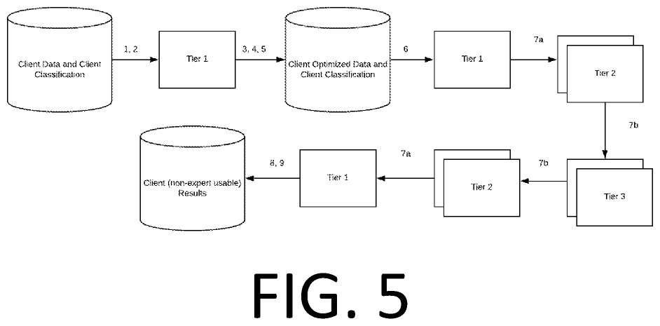

With reference now to FIG. 5, shown is the embodiment of the conceptual data pipeline. Data flows as:
1. Notification of processing requirement.
   a. This includes any sub processes and sub process initialization, control and monitoring responsible for this.
2. Initial client data set and information on wanted prediction data set.
   a. This includes any sub processes and sub process initialization, control and monitoring responsible for taking in this data set.
3. Optimization of client data.
   a. This includes the input and return data, initialization and control of processes, monitoring, cleanup and evaluation data.
4. Output of optimization information for client data.
   a. This includes any sub processes and sub process initialization, control and monitoring responsible for this.
5. Notification of client data optimization
   a. This includes any sub processes and sub process initialization, control and monitoring responsible for this.
6. Processing using optimized data set.
   a. This includes the input and return data, initialization and control of processes, monitoring, cleanup and evaluation data.
7. Data, notification and processing between tiers.
   a. This includes the input and return data, initialization and control of processes, monitoring, cleanup and evaluation data.
   b. This occurs both between (Tier 1 and Tier 2) AND between (Tier 2 and Tier 3) where Tier 2 controls, initializes, monitors, evaluates, historically compares and cleanups Tier 2 operations and processes and Tier 2 does the same for Tier 3 operations and processes.
8. Storage of the final result predictive data set.
   a. This includes any sub processes and sub process initialization, control and monitoring responsible for this.
9. Notification related to the status of the processing.
   a. This includes any sub processes and sub process initialization, control and monitoring responsible for this.
10. Note that while the data flows to each of these components, it is hidden from the teams responsible for areas outside the direct need, for example this means that client data is not available to the experts in AI/ML/MS even though they have produced a given AI/ML/MS being utilized for the operation.

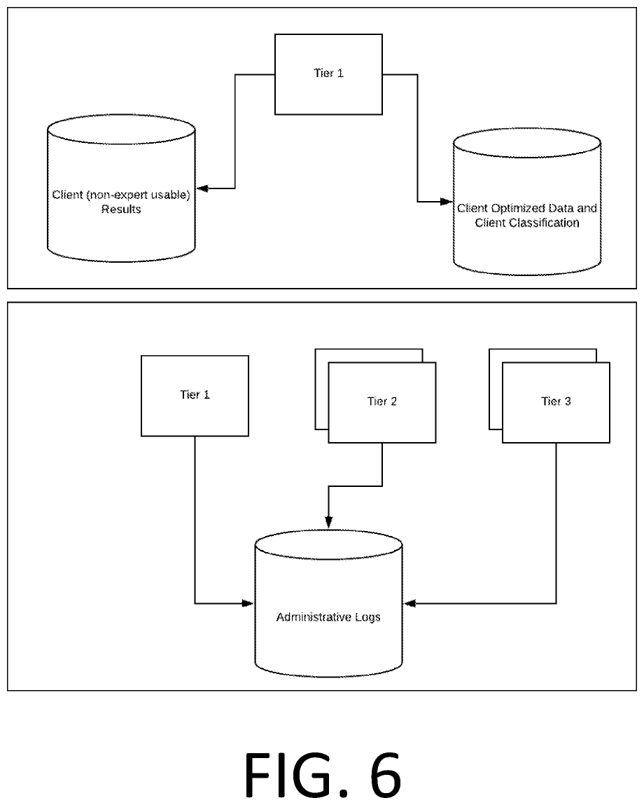

With reference now to FIG. 6, shown is the embodiment of the Response and Notification Pipeline

As detailed in [0022], [0023], [0024] the notification occurs in two cases:
1. Client notifications by tier 1.
2. Administrative notifications by all processing and pipelines described FIG. 1, 2, 3, 4. These are forwarded to their related team of experts as needed by the tier or module within a tier.

As detailed in [0022], [0023], [0024] the response occurs in two cases
1. Client notifications by tier 1 on data recommendations.
2. Result predictive data set itself by Tier 1 via processes in Tier 1, Tier 2 and Tier 3. This does not require specific implementation information, rather only evaluating runtime resources and result quality produced, etc.

With reference now to FIG. 1, is the embodiment of adding additional and or updating existing sections of Tier1, Tier2 or Tier3 systems. Embodiments may include a core suite comprised of many sub-applications described above. These systems may need to be expanded to better understand and evaluate additional real-world scenarios or to improve optimization or results throughout. Each of these sub-applications are designed to be modular such that the addition of a new or updated method added in terms described in [0022] [0023] and [0024] will be integrated and adopted throughout the specific tier and thus throughout the system as a whole.

With reference to FIG. 1, the following sections are the methods of segmenting out work to different categories of experts:
1. All Client Data and Client Results are the primary domain of the “Experts in the field of the data” (for example, if this is banking data, these would be banking data experts).
2. Tier 3 is the primary location that AI/ML/MS experts will operate in. Utilizing aggregated data analysis and logs from system wide results, the experts in these fields can focus on improving, expanding and maintain the systems and methods in Tier 3 without concern about the data or overall analysis operations.
3. Tier 2 is the primary location of IT experts to operate in, allowing for focus on software and hardware level operations which control and implement the systems deemed required by the AI/ML/MS experts while not needing specific expert knowledge about the Tier 3 operations and not needing specific knowledge of the data contents as these are both abstracted for general cases. Thus, the IT experts can focus on items such as thread performance or memory overhead etc. without the need to be concerned about specific AI/ML/MS formulas or specific client data.
4. Tier 1 is the primary location of database administrators and experts in data translation. This allows these experts to focus on operations related to improving automated data operations (such as automatic data interpretation and analysis) while not needing to be concerned with underlying operations except to note the scope of client data and to understand the data scope limitations and requirements of Tier 3 operations. However the experts operating in Tier 1 will not be required to be experts in AI/ML/MS or the client's field of data (for example they do not need to know if this is car sales data or clothing sales data or work schedule data, their operations should be capable of assuming any of a number of supported types of data sets without requiring specific details on any given data set).

The system hierarchy is configured to allow for the focus for the minimization of cross field training required to operate this system and allows for a greater flexibility in work focus with staff required to operate this system (such that an expert in Banking does not need to be an expert in AI/ML/MS and an expert in AI does not need to be an expert in large scale software development, etc.). The ability to create these tiers of modules for operation allow for each team member to focus in their field of expertise allowing easier staffing of resources in a company as well as greater efficiency of the staffing resources available (an expert in large scale software solutions does not need to be an expert in AI for example).

The system described in this documentation allows for the obfuscation of each of the following components from each other team operating in the system:
1. Data (such as to prevent restricted or private data from being seen by the AI experts, etc.)
2. AI/ML/MS implementations, to prevent clients or other teams from knowing specific proprietary or hidden formulas and calculation routines and making it difficult to reverse engineer the specific functions used to provide a given solution.
3. Specific implementation of data operations and evaluation, to prevent the knowledge of data analysis and evaluation routines to be available to clients or other teams making it difficult to reverse engineer the specific functions used to provide a given solution.
4. Specific implementations of large scale software and hardware solutions, providing a competitive advantage with the obfuscation of size and scope of servers required for these operations as well as the specific implementations on how the libraries are created that call and manage the underlying AI/ML/MS libraries, etc.

The system described in this documentation allows for secure communication to occur between:
1. Client and Tier 1
2. Tier 1 and Tier 2
3. Tier 2 and Tier 3
4. Logs and respective log recipients
5. Any authentication and authorization wrappers, connections, processing, and controllers for the processes as required to maintain secure functionality (such as connection to a LDAP system, etc.).

The system described in this documentation will connect as needed, in each Tier or module level, to any authentication and authorization wrappers, connections, processing, and controllers for the processes as required to maintain secure functionality (such as connection to a LDAP system, etc.). These will be evolving and will be standard security functionality as required by the ever-evolving security requirements in the general broader IT world. The specific security details are not critical to the core operations of this system and are envisioned as a series of wrappers for each tier or module or communication between each tier and each module (such as HTTPS communication, or encrypted data communication between tiers, etc.) for allowing the secure operation and data flow herein, to be compliant with the data security needs at the time of operation. The scope of this compliance is outside the scope of this specification.

1. A three-tiered modular system of interpreting, understanding and optimizing data input consisting of structured client case data (for example but not limited to sales data at a store), predictions generated from this data, categorization of the data and predictions, and optimization of collections of Artificial Intelligences, Machine Learning algorithms and Mathematical formulas in both formulas as well as code. Then providing response in terms of training recommendations for the client related to their data set maintenance and retention. Then providing predictive data sets to for client use. Input is in the form of structured client case data, desired prediction meta data, desired runtime metadata. Output is in the form of refinement and analysis of the input data, training and data scope analysis, recommendations on input data maintenance, predictions for the case data, operation logs.

2. The system of claim 1 wherein in Tier 1 the data is understood, determined value of datum contained and instances of Tier 2 are generated.

3. The system of claim 1 wherein in Tier 2 the data is mapped to Tier 3 and Tier 3 results are evaluated for optimization.

4. The system of claim 1 wherein in Tier 3 the predictions and or categorization are processed.

5. The system of claim 1 wherein in Tier 3 the results are passed to Tier 2 for evaluation.

6. The system of claim 1 wherein in Tier 2 the results are passed to Tier 1 for interpretation and translation to the client's nonexpert understandable results.

7. The system in claim 1 wherein in Tier 1 the data is analyzed and training for the client is provided to assist with data scope, generation, and retention practices.

8. The system in claim 1 wherein the system is comprised of three tiers and structured client input data and results.

9. The system in claim 1 wherein each tier is comprised of a plurality of containers of modular components.

10. The system of claim 1 wherein in Tier 3 there are contained modular packages of Artificial Intelligence systems, Machine Learning systems and Mathematical Systems to be maintained and expanded upon and run and results runtime information collected and returned. The specific tiered levels are to allow the modular operations and maintenance while limiting access to other tiers and ensuring communication between tiers is secure.

11. The system of claim 1 wherein in Tier 2 the packages of: Artificial Intelligence systems, Machine Learning systems and Mathematical Systems are scheduled for running, initialized, and results and runtime analyzed in a fashion determined at this tier.

12. The system of claim 1 wherein in Tier 2 the performance of Tier 3 is analyzed and improved upon.

13. The system of claim 1 wherein in Tier 1 the client data is analyzed for initialization and parameterization required for Tier 2 and Tier 3 functionality based on scope of implemented Tier 2 and tier 3 systems and operations.

14. The system of claim 1 wherein the Client provides a data set and data set classification, is returned and provides optimized data set and optimized classification and is returned for client use the client set of results in a usable translation.

15. A method allowing for segregating and restriction of data, implementation, and operations between those responsible for each tier. Where the operation of the system ensures isolation of each team working on the system to their own specific Tier and sub Tier of the system. Each Tier and sub Tier should be of limited access, to prevent any given team access to parts of the system beyond their minimal scope of operation. The isolation is possible due to the tiered system of operation.

16. The method in claim 15, where the focus is for the minimization of cross field training required to operate this system.

17. The method in claim 15, to allow for the obfuscation of each of the following components from each other team operating in the system.

18. The method in claim 15, to allow for data and runtime analysis to be analyzed across the entire system and relevant results to be filtered and set to each team as required by analyzing the meta data and runtime logs as opposed to analyzing the actual formulas or code or client data or other detailed component details.

19. The method in claim 15, to allow for communication between Client, Tier 1, Tier 2 and tier 3 operations though a structured set of communication layers to provide both functional requirements (such as what types of data and parameters are required) as well as subsequent data and logs to flow in a secure way. Each layer of communication is to be encrypted.

20. The method in claim 15, to allow for secure runtime and access to components and logs as needed to stay compliant in an evolving real-world IT environment and as required to ensure the segregation of data and access is maintained.
